(19) United States
(12) Patent Application Publication
(10) Pub. No.: US 2006/0230150 A1
(43) Pub. Date: Oct. 12, 2006

(54) Method and apparatus for assigning channels to mesh portals and mesh points of a mesh network

(75) Inventor: Vincent Roy, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/370,096

(22) Filed: Mar. 7, 2006

Related U.S. Application Data
(60) Provisional application No. 60/660,763, filed on Mar. 11, 2005.

(51) Int. Cl. G06F 15/173

(52) U.S. Cl. 709/226

(57) ABSTRACT

A radio resource management (RRM) entity which increases the capacity of a mesh network including a plurality of mesh points (MPs) and a plurality of mesh portals is disclosed. A discovery phase is performed in the mesh network such that, for each MP, the mesh network has access to information which provides a ranking of the available mesh portals and MP next-hops, and related routing metrics for each individual MP in the mesh network. A preferred mesh portal is assigned to each of the MPs in the mesh network. Each MP scans, collects, and reports channel-based measurements of all available channels. Channels are assigned to each of the mesh portals. Channels are also sequentially assigned to the MPs.

### CROSS REFERENCE TO RELATED APPLICATION

This application claims the benefit of U.S. Provisional Application No. 60/660,763, filed Mar. 11, 2005, which is incorporated by reference as if fully set forth.

### FIELD OF INVENTION

The present invention is related to a communication system having a plurality of nodes. More particularly, the present invention relates to the assignment of channels to mesh portals and mesh points (MPs) of a mesh network.

### BACKGROUND

Typical wireless system infrastructures include a set of Access Points (AP), also referred to as Base Stations (BS), each connected to a wired network through what is referred to as a backhaul link. In some scenarios, because of the high cost of connecting a given AP directly to the wired network, it would be more desirable to instead connect the AP indirectly to the wired network by transferring information to and from the neighboring APs of the given AP in a wireless fashion, otherwise referred to as a mesh infrastructure. The mesh infrastructure provides ease and speed of deployment, since a radio network can be deployed without having to provision wired backhaul links and interconnection modules for each AP.

In a mesh network, two adjacent MPs have to use a common channel to be able to forward packets to one to another. This implies that for all MPs to be able to send packets to any other point on the mesh, each MP has to be able to communicate with its neighbors using at least one common channel.

FIG. 1 shows a conventional mesh network 100 including a plurality of MPs, MP1-MP9, each equipped with only one radio transceiver. Connectivity between the MPs, MP1-MP9, is achieved by having all of the MPs, MP1-MP9, use the same channel. If any particular one of the MPs, (e.g., MP1), were to use a different channel than the rest of the MPs, (e.g., MP2-MP9), the connectivity of the mesh would be disrupted by preventing the particular MP, MP1, from receiving and forwarding packets from/to the rest of the mesh network 100.

FIG. 2 shows a conventional mesh network 200 including a plurality of MPs, MP11-MP19, each equipped with two radio transceivers, transceiver A and transceiver B, using distinct channels. It is typical for the MPs, MP11-MP19, to be configured such that the pair of transceivers of each of the MPs, MP11-MP19, use the same set of channels, (e.g., channel X and channel Y), throughout the mesh network 200 to ensure connectivity between all of the MPs, MP11-MP19. The same can be said about a mesh network where each MP is equipped with K transceivers and in which all of the MPs use the same set of channels throughout the mesh network to ensure connectivity between the different MPs of the mesh network.

The points of interconnection between a mesh network and a non-mesh network are referred to as portals. A mesh network with multiple portals is referred to as a multi-portal mesh network.

FIG. 3 shows a conventional wireless communication system 300 in accordance with the present invention. The wireless communication system 300 includes a mesh network 302 having a plurality of MPs 304a-304f, a plurality of WTRUs 306a, 306b, a router 308 and an external network 310, (e.g., a wide area network (WAN) such as the Internet).

As shown in FIG. 3, two of the MPs 304a and 304c in the mesh network 302 have mesh portals. The mesh portals 304a and 304c are connected to extra-mesh LAN resources 312, (such as Ethernet), to enable access to the network 310 via the router 308 such that a data packet may be forwarded through the extra-mesh LAN resources 312 between the mesh portals of MPs 304a and 304c. For example, if the MP 304d needs to send a packet to MP 304c, the packet would normally be routed through either MP 304b or MP 304e, which will then forward it to 304c.

Under the connectivity principles described in the previous section, it should be understood that typical mesh networks allow the routing of a packet from any MP to any other MP. However, this connectivity causes congestion because all of the MPs use the same channels, which inevitably leads to congestion as traffic increases. This greatly limits the scalability of mesh networks.

### SUMMARY

The present invention increases the capacity of multi-portal mesh networks by managing the connectivity and channel assignment in a manner that leverages the knowledge of topology and routing information in multi-portal mesh networks. In contrast to the channel assignment used in typical mesh networks which is geared towards providing connectivity, (coming at the cost of capacity and limiting the scalability of the system), the present invention allows multi-portal mesh networks, (used in offices, campus deployments, homes, or the like), to tradeoff connectivity against capacity in a manner that that will leverage the knowledge of topology and routing information.

In one embodiment, a radio resource management (RRM) entity increases the capacity of a mesh network including a plurality of MPs and a plurality of mesh portals. A discovery phase is performed in the mesh network such that, for each MP, the mesh network has access to information which provides a ranking of the available mesh portals and MP next-hops, and related routing metrics for each individual MP in the mesh network. A preferred mesh portal is assigned to each of the MPs in the mesh network. Each MP scans, collects, and reports channel-based measurements of all available channels. Channels are assigned to each of the mesh portals. Channels are also sequentially assigned to the MPs.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional mesh network including a plurality of MPs, each equipped with only one radio transceiver;

FIG. 2 shows a conventional mesh network including a plurality of MPs, each equipped with two radio transceivers using distinct channels;

FIG. 3 shows a conventional wireless communication system including a mesh network with two mesh portals;

FIG. 4 is a flow diagram of a channel assignment process implemented in a mesh network having multiple mesh portals in accordance with the present invention;

FIG. 5 is an exemplary block diagram of a mesh portal channel assignment system configured to assign channels to mesh portals of a mesh network in accordance with the present invention;

FIG. 6 shows a channel selection cost unit configured to assign channels to MPs of a mesh network in accordance with the present invention; and

FIG. 7 is an exemplary block diagram of an RRM unit for controlling a mesh network in accordance with the present invention.

### DETAILED DESCRIPTION OF THE PREFERRED EMBODIMENTS

The preferred embodiments will be described with reference to the drawing figures where like numerals represent like elements throughout.

When referred to hereafter, the terminology “wireless transmit/receive unit” (WTRU) includes but is not limited to a user equipment (UE), a mobile station, a fixed or mobile subscriber unit, a pager, or any other type of device capable of operating in a wireless environment.

The features of the present invention may be incorporated into an integrated circuit (IC) or be configured in a circuit comprising a multitude of interconnecting components.

The present invention solves the above-mentioned deficiencies of conventional wireless mesh networks by managing the MP channel assignments in a manner that leverages the knowledge of the topology and routing information of the mesh network. Ultimately, the present invention provides the best tradeoff in terms of connectivity and capacity, which are two key design characteristics of a mesh network.

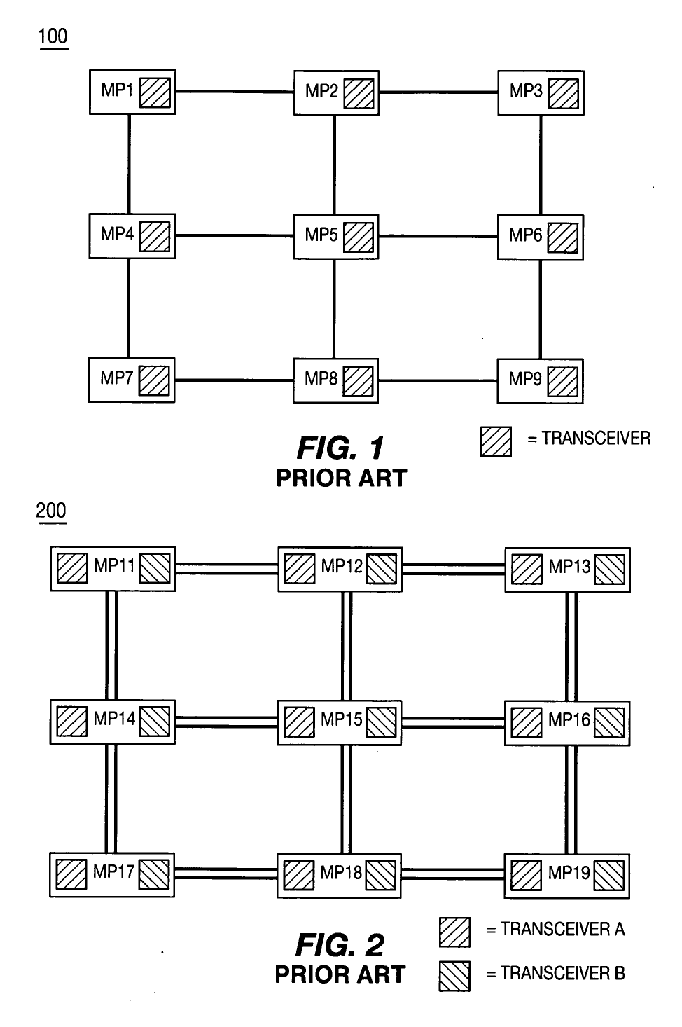

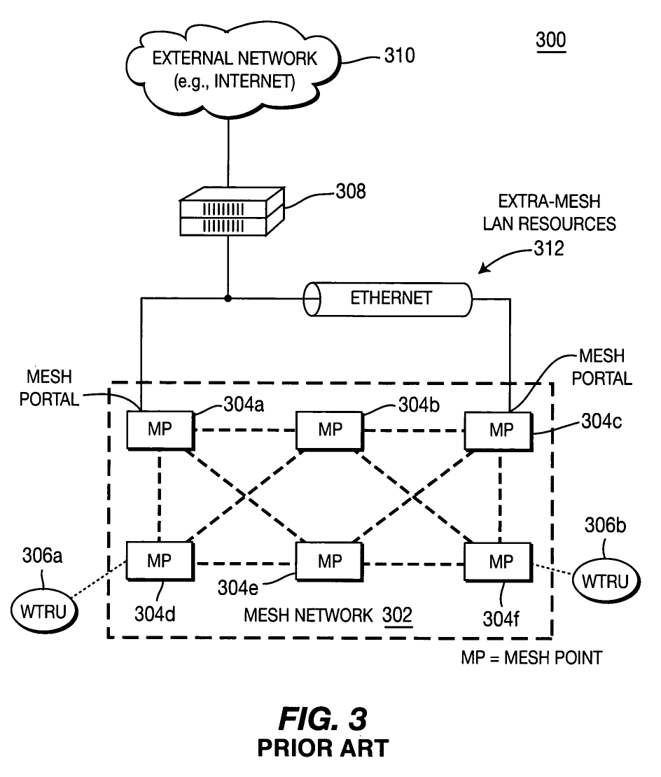

The present invention allows a multi-portal mesh network to trade-off mesh connectivity against capacity. For example, a mesh network with a plurality of MPs having only one radio transceiver, (such as the mesh network 100 of FIG. 1), but is interconnected via two portals, could capitalize on the fact that routing algorithms will favor routing packets to/from a first subset of MPs using a first mesh portal while a second mesh portal would be favored when dealing with a second subset of MPs. By assigning different channels to groups of MPs, the connectivity in the mesh is reduced. For example, a particular channel arrangement in a mesh network may make it impossible for a packet sent by a first MP in a mesh network to be routed through a second MP in the mesh network. Still, by making good use of the knowledge of the topology and the routing information of the mesh network, the present invention minimizes the negative impact associated with the reduced connectivity while increasing the capacity of the air interface used by the mesh network; similar to the way two channels can now be used simultaneously in the mesh network instead of one.

The concept described above for a mesh network equipped with single radio transceivers, as shown in FIG. 1, can also be applied to mesh networks with multi-radio transceivers, as shown in FIG. 2. Such a scenario might not lead to solutions where it is desirable to completely split a mesh network into multiple clusters, which could lead to a solution where partial connectivity can be maintained by having some MPs of a given cluster use a subset of the channels associated with different clusters.

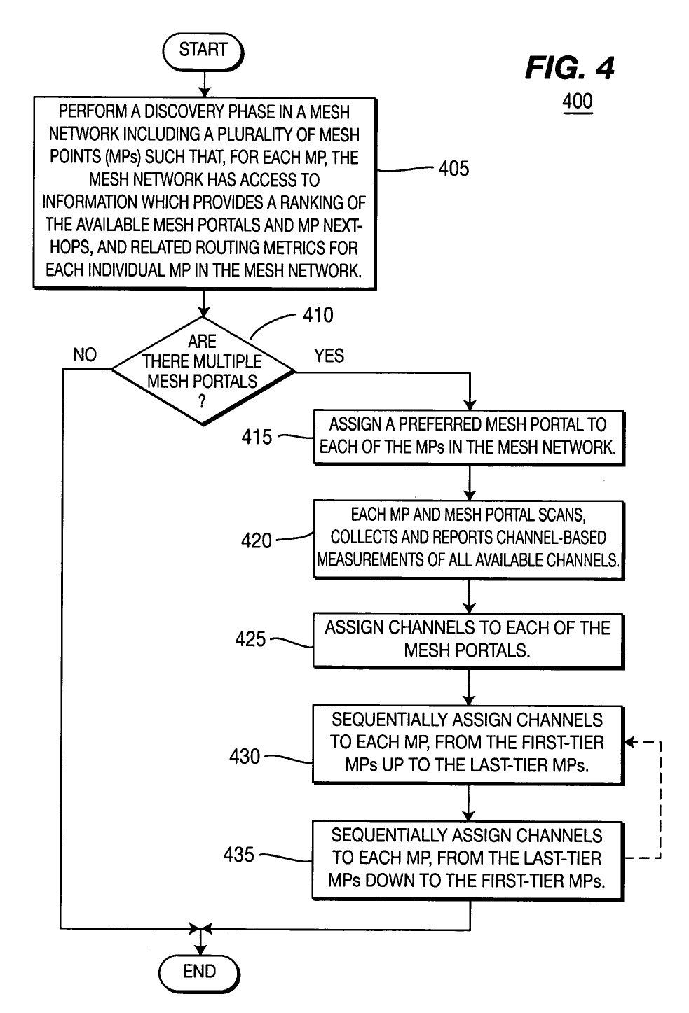

FIG. 4 is a flow diagram of a channel assignment process 400 implemented in a mesh network in accordance with the present invention. It is assumed that the mesh network possesses a certain amount of information about the topology of the mesh network. More specifically, it is assumed that the mesh network has already performed a discovery phase at the end of which the following are known:

i) MPs equipped with portals are identified as such.

ii) Routing tables consisting of a list of portals available to each MP, as well as a list of the available next hops allowing each MP to forward packets to each of the available mesh portal destinations is determined. It is also assumed that routing metrics have been collected and associated to each of the elements of the above-mentioned routing tables.

iii) In a preferred embodiment, the routing tables described above are sufficient to be able to identify the preferred mesh portal of each MP, as well as the number of hops each MP needed to reach the preferred mesh portal. This information is used to categorize MPs in tiers. A first-tier MP consists of MPs that can reach a preferred mesh portal in a single hop. A second tier MP consists of MPs that can reach a preferred mesh portal in two hops. A kth-tier MP consists of MPs that can reach a preferred mesh portal in k hops. The information which indicates which tier a certain MP corresponds to will be referred to as a topology metric Tᵢ, where i=1. M refers to the topology metric of MPᵢ and Tᵢ=k, indicating that MPᵢ is a kth-tier MP. It should be noted that even the mesh portal is assigned a topology metric. In the preferred embodiment, the topology metric of a mesh portal would be zero, signifying that the mesh portal is zero hops away from the closest mesh portal.

Referring to FIG. 4, the process 400 begins in step 405 by performing a Discovery phase in a mesh network, which includes a plurality of MPs, has access to information which provides a ranking of available mesh portals and MP next-hops, and related routing metrics for each individual MP in the mesh network. Based on this information, each of the MPs in the mesh network may be characterized as one of a first-tier MP, a second-tier MP, . . . , a kth-tier MP. In step 410, a determination is made as to whether there are multiple mesh portals in the mesh network. If there are no mesh portals or only one mesh portal in the mesh network, the process 400 ends. If there are multiple mesh portals, the process 400 proceeds to step 415, where a master RRM unit, (either centralized or distributed in each MP), assigns a preferred mesh portal to each of the MPs in the mesh network. In a preferred embodiment, this assignment requires consulting the routing table of an MP and identifying the mesh portal corresponding to the route with the best routing metric. A mesh portal, and all of the MPs to which the mesh portal is assigned, are referred to as a cluster.

Referring still to FIG. 4, each MP and mesh portal scans and collects channel-based measurements of all available channels, and reports the results of these measurements to a master RRM unit (step 420). The reported channel scanning metrics, (i.e., the channel scanning reports), are referred to as Sᵢⱼ, where for i=1, M corresponds to the MP index and for j=1, N corresponds to the channel index. The MP index identifies specific MPs, where M is the number of MPs in the mesh network. The channel index identifies specific channels and N corresponds to the number of available channels in the mesh network. For example, if the mesh network has 5 MPs, M=5. If the mesh network has access to 8 available channels, N=8. The scanning metrics include but are not limited to channel occupancy, interference measurements, number of measured co-channel interferences, or the like.

As indicated in step 425 of FIG. 4, channels are assigned to each of the mesh portals. In step 430, channels are sequentially assigned to the MPs, starting with all first-tier MPs of the mesh network, followed by all second-tier MPs, . . . , and so on until channels have been selected for all of the MPs in the mesh network. In step 435, the channels are sequentially assigned to the MPs, starting with the last-tier MP, (i.e., the kth-tier), down to the first-tier MP. This two-step process can be repeated multiple times and/or periodically, and it allows the mesh network to converge towards a stable solution.

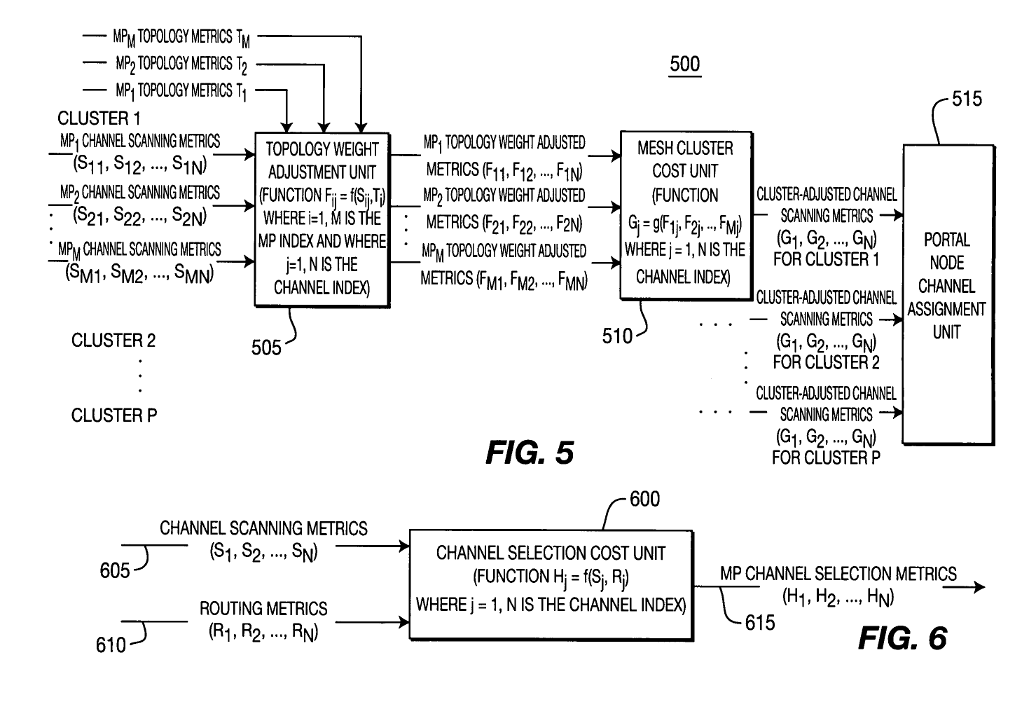

FIG. 5 is an exemplary block diagram of an MP channel assignment system 500 which is configured to perform step 425 of the process 400 of FIG. 4 in accordance with the present invention. The MP channel assignment system 500 may be incorporated into an RRM, (either centralized or distributed in each MP). The MP channel assignment system 500 includes a topology weight adjustment unit 505, a mesh cluster cost unit 510 and a portal node channel assignment unit 515. The system 500 may be configured to include multiple topology weight adjustment units 505 and multiple mesh cluster cost units 510 such that the channel scanning metrics and topology metrics associated with different clusters 1, 2, . . . , P may be processed simultaneously.

As shown in FIG. 5, topology weight adjustment unit 505 of the MP channel assignment system 500 receives MP channel scanning metrics, Sᵢⱼ, where the MP index i ranges from 1 to M, the channel index j ranges from 1 to N, and also receives MP topology metrics, Tᵢ, where the MP index i ranges from 1 to M. These two sets of metrics are processed using a function, Fᵢⱼ=f(Sᵢⱼ, Ti), to assign a different weight to different ones of the MPs in accordance with the amount of traffic each MP is expected to carry. For example, a first-tier MP is likely to have to carry the traffic forwarded by a second-tier MP, a third-tier MP, and so on. Thus, the topology weight adjustment unit 505 allows the assignment of a greater importance, (or weight), to the MPs that will ultimately carry more traffic because of its proximity to the mesh portal. The topology weight adjustment unit 505 outputs MP topology weight adjusted metrics, Fᵢⱼ, which are then input into the mesh cluster cost unit 510 which processes the MP topology weight adjusted metrics, Fᵢⱼ, using a function, Gj=g(F₁ⱼ, F₂ⱼ, . . . , F_{Mj}), to merge the MP topology weight adjusted metrics associated with each channel into a single cluster-adjusted channel scanning metric per channel. The cluster-adjusted channel scanning metrics, (G₁, G₂, . . . , G_{N}), obtained for each cluster 1, 2, . . . , P, are then fed into the portal node channel assignment unit 515, which uses a channel allocation algorithm to assign channels to the mesh portals of the mesh network.

FIG. 6 shows a channel selection cost unit 600 which assigns channels to MPs by performing steps 430 and 435 of the process 400 of FIG. 4 in accordance with the present invention. As shown in FIG. 6, channel scanning metrics 605, (Sⱼ, where j is the channel index ranging from 1 to N), associated to a single MP as well as routing metrics 610, (Rⱼ, where j is the channel index ranging from 1 to N), is input to the channel selection cost unit 600 which performs a function Hⱼ=f(Sⱼ,Rⱼ). The routing metrics Rⱼ correspond to the routing metric associated to the preferred route leading to the MP's preferred portal that uses channel i. Rⱼ can be determined when mesh portals have been assigned channels and that the mesh network has access to the routing tables of each MP. In the case where a certain MP would not have any routing metric associated with a certain channel, (which could be the case if no portal in the mesh network uses the channel or if such a portal is not included in the routing table of the MP), the routing metric could be fixed to a pre-determined value indicating that such channel cannot be used by the MP. In order to select which channels an MP should use, it is sufficient to pick the channels associated to the best MP channel selection metrics Hj output from the channel selection cost function.

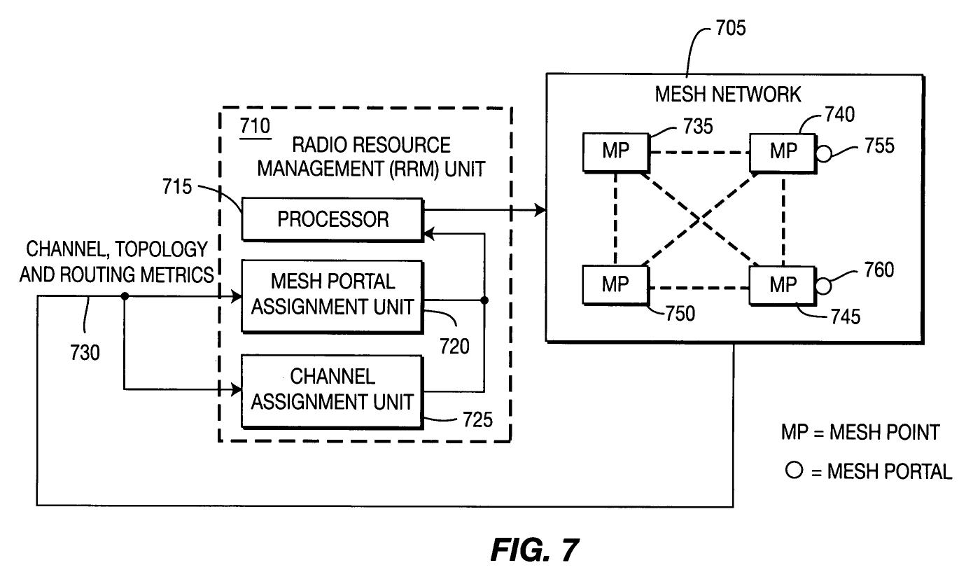

FIG. 7 is an exemplary block diagram of an RRM unit 710 for controlling a mesh network 705 in accordance with the present invention. The RRM unit 710 includes a processor 715, a mesh portal assignment unit 720 and a channel assignment unit 725. Each of the mesh portal assignment unit 720 and the channel assignment unit 725 receive channel scanning metrics, topology metrics and routing metrics 730 from the mesh network 705. The mesh network includes a plurality of MPs 735, 740, 750, 755, and at least two mesh portals 755, 760.

The processor 715 performs a discovery phase in the mesh network 705 such that, for each MP 735, 740, 745, 750, the mesh network 705 has access to information which provides a ranking of the available mesh portals 755, 760, and MP next-hops, and related routing metrics for each individual MP in the mesh network 705.

The mesh portal assignment unit 720 receives the channel scanning metrics, topology metrics and routing metrics 730 reported by the MPs 735, 740, 745, 750 of the mesh network 705 and, based on the topology metrics and routing metrics, assigns a preferred mesh portal 755, 760, to each of the MPs 735, 740, 745, 750 in the mesh network 705.

The channel assignment unit 725 receives the channel scanning metrics, topology metrics and routing metrics 730 reported by the MPs 735, 740, 745, 750 of the mesh network 705, assigns channels to each of the mesh portals 755, 760 and sequentially assigns channels to the MPs 735, 740, 745, 750.

The channel assignment unit 725 sequentially assigns channels to each MP 735, 740, 745, 750, from first-tier MPs up to last-tier MPs. The first-tier MPs reach a preferred mesh portal in a single hop and last-tier MPs reach a preferred mesh portal in a plurality of hops. The channel assignment unit 725 also sequentially assigns channels to each MP 735, 740, 745, 750, from last-tier MPs down to first-tier MPs.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for increasing the capacity of a multi-portal mesh network, the method comprising:
(a) performing a discovery phase in a mesh network including a plurality of mesh points (MPs) such that, for each MP, the mesh network has access to information which provides a ranking of the available mesh portals and MP next-hops, and related routing metrics for each individual MP in the mesh network;
(b) determining whether there are multiple mesh portals in the mesh network, wherein if the determination in step (b) is positive, performing the following steps:
(c) assigning a preferred mesh portal to each of the MPs in the mesh network;
(d) each MP scanning, collecting, and reporting channel-based measurements of all available channels;
(e) assigning channels to each of the mesh portals; and
(f) assigning channels to the MPs sequentially.

2. The method of claim 1 wherein step (f) further comprises sequentially assigning channels to each MP, from first-tier MPs up to last-tier MPs.

3. The method of claim 2 wherein first-tier MPs reach a preferred mesh portal in a single hop and last-tier MPs reach a preferred mesh portal in a plurality of hops.

4. The method of claim 1 wherein step (f) further comprises sequentially assigning channels to each MP, from last-tier MPs down to first-tier MPs.

5. The method of claim 4 wherein first-tier MPs reach a preferred mesh portal in a single hop and last-tier MPs reach a preferred mesh portal in a plurality of hops.

6. A radio resource management (RRM) unit for controlling a mesh network, the mesh network including a plurality of mesh points (MPs) and at least two available mesh portals, the RRM unit comprising:
(a) a processor for performing a discovery phase in the mesh network such that, for each MP, the mesh network has access to information which provides a ranking of the available mesh portals and MP next-hops, and related routing metrics for each individual MP in the mesh network;
(b) a mesh portal assignment unit in communication with the mesh network and the processor, the mesh portal assignment unit being configured to receive topology metrics and routing metrics reported by the MPs of the mesh network and assign a preferred mesh portal to each of the MPs in the mesh network based on the topology metrics and routing metrics; and
(c) a channel assignment unit in communication with the mesh network and the processor, the channel assignment unit being configured to receive channel scanning metrics, topology metrics and routing metrics reported by the MPs of the mesh network, and assign channels to each of the mesh portals and sequentially assign channels to the MPs based on the channel scanning metrics, topology metrics and routing metrics.

7. The RRM unit of claim 6 wherein the channel assignment unit sequentially assigns channels to each MP, from first-tier MPs up to last-tier MPs.

8. The RRM unit of claim 7 wherein first-tier MPs reach a preferred mesh portal in a single hop and last-tier MPs reach a preferred mesh portal in a plurality of hops.

9. The RRM unit of claim 6 wherein the channel assignment unit sequentially assigns channels to each MP, from last-tier MPs down to first-tier MPs.

10. The RRM unit of claim 9 wherein first-tier MPs reach a preferred mesh portal in a single hop and last-tier MPs reach a preferred mesh portal in a plurality of hops.

11. An integrated circuit (IC) incorporated in a radio resource management (RRM) unit for controlling a mesh network, the mesh network including a plurality of mesh points (MPs) and at least two available mesh portals, the IC comprising:
(a) a processor for performing a discovery phase in the mesh network such that, for each MP, the mesh network has access to information which provides a ranking of the available mesh portals and MP next-hops, and related routing metrics for each individual MP in the mesh network;
(b) a mesh portal assignment unit in communication with the mesh network and the processor, the mesh portal assignment unit being configured to receive topology metrics and routing metrics reported by the MPs of the mesh network and assign a preferred mesh portal to each of the MPs in the mesh network based on the received topology metrics and routing metrics; and
(c) a channel assignment unit in communication with the mesh network and the processor, the channel assignment unit being configured to receive channel scanning metrics, topology metrics and routing metrics reported by the MPs of the mesh network, and assign channels to each of the mesh portals and sequentially assign channels to the MPs based on the received channel scanning metrics, topology metrics and routing metrics.

12. The IC of claim 11 wherein the channel assignment unit sequentially assigns channels to each MP, from first-tier MPs up to last-tier MPs.

13. The IC of claim 12 wherein first-tier MPs reach a preferred mesh portal in a single hop and last-tier MPs reach a preferred mesh portal in a plurality of hops.

14. The IC of claim 11 wherein the channel assignment unit sequentially assigns channels to each MP, from last-tier MPs down to first-tier MPs.

15. The IC of claim 14 wherein first-tier MPs reach a preferred mesh portal in a single hop and last-tier MPs reach a preferred mesh portal in a plurality of hops.

16. A mesh point (MP) channel assignment system used in a mesh network including a plurality of MPs, the MP channel assignment system comprising:
(a) a topology weight adjustment unit for: (i) receiving MP channel scanning metrics having an MP index i ranging from 1 to M and a channel index ranging from 1 to N, (ii) receiving MP topology metrics having an MP index ranging from i to M, and (iii) outputting MP topology weight adjusted metrics;
(b) a mesh cluster cost unit in communication with the topology weight adjustment unit, the mesh cluster cost unit being configured to process the MP topology weight adjusted metrics to merge the MP topology weight adjusted metrics associated with each channel into a single cluster-adjusted channel scanning metric per channel; and
(c) a portal node channel assignment unit in communication with the mesh cluster cost unit, the portal node channel assignment unit being configured to process the cluster-adjusted channel scanning metrics obtained for each of a plurality of clusters using a channel allocation algorithm to assign channels to mesh portals of a mesh network.

17. The system of claim 16 wherein the topology weight adjustment unit allows the assignment of a greater weight to a particular MP that carries more traffic because of the proximity of the particular MP to a mesh portal.

18. An integrated circuit (IC) incorporated in a mesh network including a plurality of MPs, the IC comprising:
(a) a topology weight adjustment unit for: (i) receiving MP channel scanning metrics having an MP index i ranging from 1 to M and a channel index ranging from 1 to N, (ii) receiving MP topology metrics having an MP index ranging from i to M, and (iii) outputting MP topology weight adjusted metrics;
(b) a mesh cluster cost unit which processes the MP topology weight adjusted metrics to merge the MP topology weight adjusted metrics associated with each channel into a single cluster-adjusted channel scanning metric per channel; and
(c) a portal node channel assignment unit for processing the cluster-adjusted channel scanning metrics obtained for each of a plurality of clusters using a channel allocation algorithm to assign channels to mesh portals of a mesh network.

19. The IC of claim 18 wherein the topology weight adjustment unit allows the assignment of a greater weight to a particular MP that carries more traffic because of the proximity of the particular MP to a mesh portal.
